(19) United States
(12) Patent Application Publication
(10) Pub. No.: US 2016/0234674 A1
(43) Pub. Date: Aug. 11, 2016

(54) A Method for Controlling 3GPP-WLAN Interworking and Devices for Use Therein

(71) Applicant: TELEFONAKTIEBOLAGET L M ERIC - SSON ( PUBL), Stockholm (SE)

(72) Inventor: Patrick Maguire, Westmeath (IE)

(73) Assignee: Telefonaktiebolaget LM Ericsson (publ), Stockholm (SE)

(21) Appl. No.: 15/024,690

(22) PCT Filed: Sep. 30, 2013
(86) PCT No.: PCT/EP2013/070381

§ 371 Date: Mar. 24, 2016

(51) Int. Cl. H04W 8/02; H04W 64/00; H04W 28/02; H04W 48/16

(52) U.S. Cl. CPC H04W 8/02; H04W 48/16; H04W 64/006; H04W 28/0226; H04W 84/12

(57) ABSTRACT

A method in a wireless terminal operating in a 3GPP wireless communications network for controlling interworking with a Wireless Local Area Network, WLAN. The method comprises receiving (202) system information comprising a parameter defining a condition for interworking with a WLAN network associated with mobility characteristics of the wireless terminal and determining (204) a parameter indicative of mobility characteristics of the wireless terminal. The wireless terminal disables (208) interworking with a WLAN network if the parameter indicative of mobility characteristics does not meet the condition (206).

### TECHNICAL FIELD

The present invention relates to wireless communications networks, in general, and in particular to controlling mobile terminal interworking between 3GPP network and WLAN network.

### BACKGROUND

With the advent of mobile internet services provided in mobile communications networks rely more and more on data services. Streaming video clips to mobile phones or tablets, voice over IP calls and regular internet browsing are now all possible on mobile devices. Wireless communications networks based on 3rd-Generation Partnership Project (3GPP) technologies (these include radio-access technologies known as Long-Term Evolution (LTE), Universal Mobile Telecommunications System/Wideband Code-Division Multiple Access (UMTS/WCDMA), and Global System for Mobile Communications (GSM)) have limited bandwidth and ever-increasing number of devices capable of using data services on the go results in dramatic increase of mobile data consumption.

In search for additional bandwidth, wireless network operators turned their attention to WiFi, which is widely used in Wireless Local Area Networks (WLAN). The network operators and suppliers of network equipment considered the possibility of using WiFi for purposes extending beyond the role of indoor access to broadband services. Smartfones, and other devices (referred to hereinafter as “user equipment,” or “UE”) using 3GPP access networks are today equipped with WiFi interface. Initially this WiFi capability of smartphones was intended for accessing Internet and other data services when the user was indoor where he or she had access to a WiFi network. The decision to switch data connection to WiFi is made in these devices without support from the 3GPP network. The UE detects WiFi network and switches data connection from the 3GPP network to the WiFi network if it is authorised to use said WiFi network. These WLAN networks in user's homes or offices are not really part of the wireless communications network controlled by the operator. They are private networks that can support individual users rather than wider public.

To address growing demands for increased network data capacity, operators are leveraging on WiFi coupled with their macro/pico cell deployments to enable capacity offload is a cost effective manner. From the operator's perspective using WiFi access networks brings number of benefits:
WiFi operates on free (i.e. unlicensed) spectrum, which means there is no need for expensive and time consuming work needed to satisfy local regulations.
WiFi offers huge network capacity boost.
Simplified network procurement processes, this is partly related to WiFi operating on unlicensed spectrum.
Lower Capex investment required compared to other solutions (e.g. so called micro and pico cells).

WLAN-3GPP system interworking is defined as a wireless IP connectivity service where the user obtains access via a Wireless LAN technology. It shall be possible to deploy the WLAN as an integral part of the 3GPP system or the two systems can be separate. The 3GPP system shall be capable of interworking with one or more WLANs and a WLAN shall be capable of interworking with one or more 3GPP systems. More details on 3GPP system to Wireless Local Area Network (WLAN) interworking can be found in 3GPP TS 22.234 V11.0.0 (2012-09) and 3GPP TS 23.234 V11.0.0 (2012-09).

### SUMMARY

It is the object of the present invention to obviate at least some of the above disadvantages and provide an improved method and apparatus for controlling of 3GPP WLAN interworking.

Accordingly, the invention seeks to preferably mitigate, alleviate or eliminate one or more of the disadvantages mentioned above singly or in any combination.

According to a first aspect of the present invention there is provided a method in a wireless terminal operating in a 3GPP wireless communications network for controlling interworking with a Wireless Local Area Network, WLAN. The method comprises receiving system information comprising a parameter defining a condition for interworking with a WLAN network. The condition is associated with mobility characteristics of the wireless terminal. The method also comprises determining a parameter indicative of mobility characteristics of the wireless terminal and disabling interworking with a WLAN network if the parameter indicative of mobility characteristics does not meet the condition.

According to a second aspect of the present invention there is provided a method in a node of a 3GPP wireless communications network for controlling interworking of a wireless terminal between the 3GPP wireless communications network and a Wireless Local Area Network, WLAN. The method comprises setting a parameter defining a condition for interworking with a WLAN network associated with mobility characteristics of a wireless terminal and adding said parameter defining a condition for interworking to system information. The method further comprises sending said system information to a wireless terminal, wherein said condition associated with said mobility characteristics causes disabling interworking with the WLAN network if a parameter indicative of mobility characteristics of the terminal does not meet the condition.

According to a third aspect of the present invention there is provided a wireless terminal for a 3GPP wireless communications network. The wireless terminal comprises a processor and a memory. Said memory contains instructions executable by said processor. The wireless terminal is configured to receive system information comprising a parameter defining a condition for interworking with a WLAN network associated with mobility characteristics of the wireless terminal and to determine a parameter indicative of mobility characteristics of the wireless terminal. The wireless terminal is further configured to disable interworking with a WLAN network if the parameter indicative of mobility characteristics does not meet the condition.

According to a fourth aspect of the present invention there is provided a node for a 3GPP wireless communications network. The node is configured for controlling interworking of a wireless terminal between the 3GPP wireless communications network and a Wireless Local Area Network, WLAN. The node comprises a processor and a memory. Said memory contains instructions executable by said processor whereby said node is configured to set a parameter defining a condition for interworking with a WLAN network associated with mobility characteristics of a wireless terminal and add said parameter defining a condition for interworking to system information. The node is further configured to send said system information to a wireless terminal, wherein said condition associated with said mobility characteristics causes disabling interworking with the WLAN network if the parameter indicative of mobility characteristics of the terminal does not meet the condition.

According to a fifth aspect of the present invention there is provided a wireless terminal for a 3GPP wireless communications network. The wireless terminal comprises a receiving module for receiving system information comprising a parameter defining a condition for interworking with a WLAN network associated with mobility characteristics of the wireless terminal and a determining module for determining a parameter indicative of mobility characteristics of the wireless terminal. The wireless terminal further comprises a checking module for checking if the determined parameter indicative of mobility characteristics of the wireless terminal meets the condition for interworking with a WLAN network and an interworking module for disabling interworking with a WLAN network if the parameter indicative of mobility characteristics does not meet the condition.

According to a sixth aspect of the present invention there is provided a node for a 3GPP wireless communications network. The node is configured for controlling interworking of a wireless terminal between the 3GPP wireless communications network and a Wireless Local Area Network, WLAN. The node comprises a setting module for setting a parameter defining a condition for interworking with a WLAN network associated with mobility characteristics of a wireless terminal and an adding module for adding parameter defining a condition for interworking to system information. The node further comprises a sending module for sending said system information to a transceiver of the node for a wireless transmission to a wireless terminal, wherein said condition associated with said mobility characteristics causes disabling interworking with the WLAN network if the parameter indicative of mobility characteristics of the terminal does not meet the condition.

Further features of the present invention are as claimed in the dependent claims.

Advantageously the invention allows for optimization of user experience and minimization of network signalling load for wireless terminals which are classified as Fast Moving Mobiles (FFM) as determined by operator, when transitioning in and out of WLAN coverage while connected to a 3GPP radio access network.

### BRIEF DESCRIPTION OF THE DRAWINGS

The present invention will be understood and appreciated more fully from the following detailed description taken in conjunction with the drawings in which:

FIG. 1 is a diagram illustrating a wireless terminal travelling through a 3GPP cell with WLAN networks overlapping the 3GPP cell;

FIG. 2 is a diagram illustrating a method in a wireless terminal for controlling 3GPP WLAN interworking in one embodiment of the present invention;

FIG. 3 is a diagram illustrating a method in a wireless terminal for controlling 3GPP WLAN interworking in one embodiment of the present invention;

FIG. 4 is a diagram illustrating a method in a network node for controlling 3GPP WLAN interworking in one embodiment of the present invention;

FIG. 5 is a diagram illustrating a wireless terminal in one embodiment of the present invention;

FIG. 6 is a diagram illustrating a network node in one embodiment of the present invention;

FIG. 7 is a diagram illustrating a wireless terminal in alternative embodiment of the present invention;

FIG. 8 is a diagram illustrating a network node in alternative embodiment of the present invention.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary details.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

The term “wireless terminal” used in this document refers to devices also known as user equipment (UE) that communicate via a radio access network (RAN) with one or more core networks. As used herein, a wireless terminal can include any device that communicates through a wireless channels with a communication network, and may include, but is not limited to, a mobile telephone (“cellular” telephone), laptop computer, tablet computer, game console, and/or a machine-type communications (MTC) device.

Although advantages of a 3GPP network interworking with a WLAN network are clear it may be further improved. The inventor has recognized that the normative documents defining 3GPP system to Wireless Local Area Network (WLAN) interworking fail to recognise small size of a WiFi cell and implication of it for interworking if the UE is not stationary. In deciding to connect to a WLAN access network no consideration is made for the mobility characteristics of the current UE 3GPP connection. Therefore the 3GPP system to Wireless Local Area Network (WLAN) interworking can be further improved if in deciding on interworking with WLAN access network mobility characteristics of the wireless terminal is taken into account.

In the deployment scenario of 3GPP and WiFi access networks, as shown in FIG. 1, where the WiFi access network is classified as an Interworking WLAN (I-WLAN) and the wireless terminal 104 is not stationary the outcome on moving from 3GPP 102 to WiFi 106-112 is illustrated. Giving consideration to the fact that the geographical coverage of a WiFi Access Points (AP) 106-112 is small (approx. 100 m in open space) and fact that wireless terminal 104 travels 114 (e.g. in a car) the result will be a WiFi AP ping-pong due mobility of the wireless terminal-the wireless terminal stays in the range of a particular WLAN access point (AP) for a very short period of time. This, in turn leads to:
possible service interruption and signaling storms;
unnecessary battery consumption;
most importantly of all poor user experience.

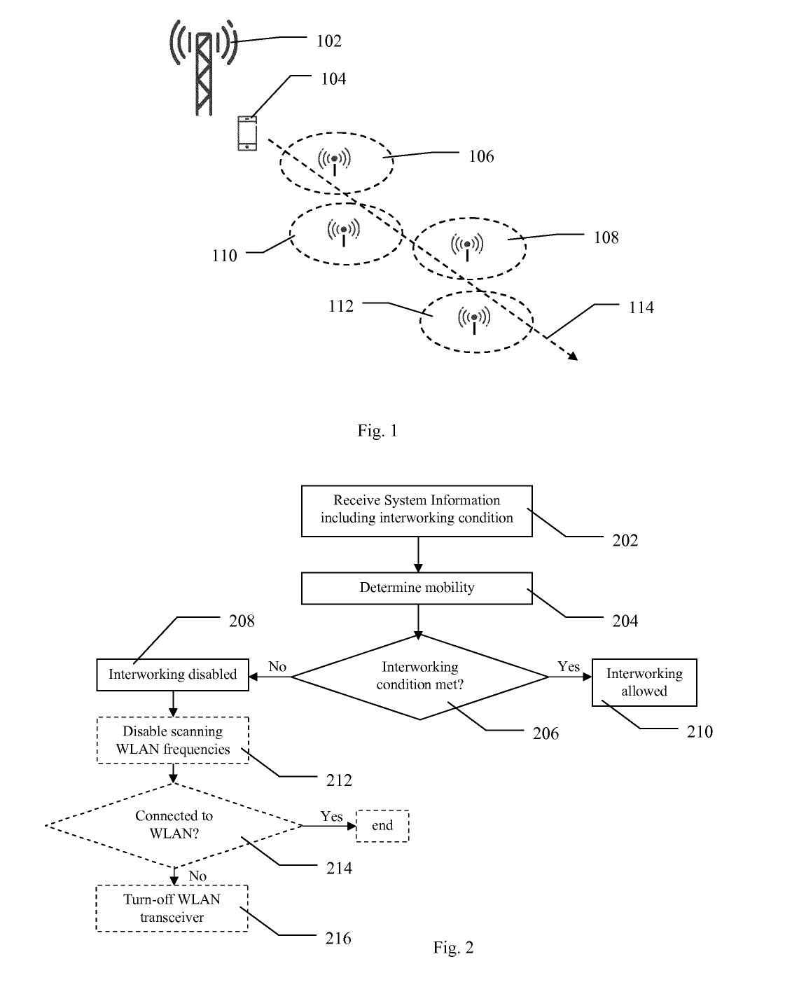

With reference to FIG. 2 an embodiment of a method for controlling interworking of a wireless terminal operating in a 3GPP network with a Wireless Local Area Network, WLAN, is described. The method is implemented in the wireless terminal. In operation, the wireless terminal receives, 202, system information comprising a parameter defining a condition for interworking with a WLAN network and this condition is associated with mobility characteristics of the wireless terminal. Once the condition is received the wireless terminal determines, 204, a parameter indicative of its mobility characteristics. If the determined parameter indicative of mobility of the wireless terminal does not meet the condition, 206, then interworking with a WLAN network is not allowed and the mobile terminal disables 208 interworking. Otherwise, if the condition is met, the interworking is allowed, 210, and the wireless terminal may connect to WLAN network if it is in a range of one.

In a preferred embodiment the parameter indicative of mobility of the wireless terminal is determined based on 3GPP Technical Specification 36.304 V11.5.0. This document introduces and defines three states of mobility of a wireless terminal: Normal, Medium and High. Mobility is determined based on a number of cell reselections during a defined period of time. If the number of cell reselections during this defined period of time is does not exceed a first defined value T1 then the mobility of this wireless terminal is Normal. If the number of cell reselections is above T1 but does not exceed a second defined value T2 then the mobility of the wireless terminal is Medium. Finally, if the number of cell reselections is above T2 then the mobility of the wireless terminal is High.

In order to prevent falsifying the counts of cell reselections in the case of the wireless terminals operating close to a border between two adjacent cells the 3GPP 36.304 document explains that the wireless terminal shall not count consecutive reselections between same two cells into mobility state detection criteria if same cell is reselected just after one other reselection.

Further details of determining mobility characteristics are not subject of the present invention and will not be discussed in this document. However, these details are described in the above identified document and a person skilled in the art would have no problem with implementing these in practice.

An important advantage of using the mobility states of a wireless terminal as defined in the 3GPP 36.304 document is that mechanisms for determining this information are readily available and standardised, which makes implementation of embodiments of the present invention relatively easy. Additionally, determining the mobility characteristics based on specific events in the network as suggested in 3GPP 36.304 has the advantage that it is not necessary to use GPS data or triangulation in order to determine change of position of the wireless terminal. Using GPS and triangulation may be accurate, but at the same time it consumes battery (GPS) and computation resources (triangulation). The present invention inherits these advantages by relying on mobility states as defined in 3GPP 36.304.

In a preferred embodiment in System Information the following additional parameters defining conditions for interworking are added to cell information:
UeMobilityMedium3gppWlanInterworking [Allowed, Not Allowed]
UeMobilityHigh3gppWlanInterworking [Allowed, Not Allowed]

Each of these parameters effectively defines a condition for a receiving wireless terminal. The condition determines if 3GPP-WLAN interworking is allowed or not depending on mobility characteristics.

System information (SI) is a general term applicable to information provided to a wireless terminal and this information covers a functional area. System information is sent by the network to the wireless terminal in a structured manner and it consists of many System Information Blocks (messages) known as SIBs. There is a SIB called MIB (Master Information Block), which specifies the structure of the other SIBs. A SIB generally covers a functional area, e.g. system level parameters, cell specific parameters, handover related parameters, etc. More details on system information can be found in 3GPP TS 25.331 V11.6.0 (chapters 8 and 10.2.48).

Among the SIBs defined in TS 25.331 SIB 3 has parameters for cell selection and Reselection and SIB 4 has parameters for cell selection and Reselection more specifically when the wireless terminal is in Connected Mode. For this reason the above parameters defining conditions for 3GPP-WLAN interworking are preferably added to SIB 3 or SIB 4. In alternative embodiment the 3GPP-WLAN interworking parameters are added to both SIB 3 and SIB 4. It is, however, possible to include the 3GPP-WLAN interworking parameters in other SIBs.

In addition to the information provided to the wireless terminal by the network which enable the wireless terminal to determine if the wireless terminal currently has Normal, Medium or High mobility, the operator can use the above two parameters defining conditions for interworking on a per cell basis to effectively enable or disable 3GPP-WLAN interworking based on the mobility state of the wireless terminal.

In one embodiment it is possible to use only one of these 3GPP-WLAN interworking parameters. For example if the wireless terminal received UeMobilityMedium3gppWlanInterworking [Not Allowed] it would know that interworking is not allowed for wireless terminals having mobility characteristics High without the need for any additional information from the SIB. However, if interworking is allowed for Medium mobility then both 3GPP-WLAN interworking parameters are needed if interworking is not allowed for high mobility. In this situation the SIB includes:
UeMobilityMedium3gppWlanInterworking [Allowed]
UeMobilityHigh3gppWlanInterworking [Not Allowed]

In yet another embodiment, when interworking is allowed for Medium mobility and also for High mobility then it is enough to include in the SIB:
UeMobilityHigh3gppWlanInterworking [Allowed]
   because it would be clear that interworking for Medium mobility is also allowed.

Similarly, if interworking is not allowed for Medium mobility it is enough to include just one line in the SIB:
UeMobilityMedium3gppWlanInterworking [Not Allowed]
   because it would be clear that interworking for High mobility is not allowed either.

Once the wireless terminal receives the 3GPP-WLAN interworking parameter and knows its mobility characteristics it is able to determine if it is allowed or not allowed to interwork with a WLAN network. In this way the wireless terminal can easily avoid connecting to a WLAN network only to be disconnected after a short period of time. This, in consequence allows for reducing battery consumption and improves user's experience.

In a preferred embodiment an algorithm operating in the wireless terminal may be as follows;

```
      IF
      UE mobility state is NORMAL proceed with 3GPP-WLAN
interworking according to standards
      ELSEIF
      UE mobility state is MEDUM and cell parameter
UeMobilityMedium3gppWlanInterworking is set to Not Allowed, block
3GPP-WLAN interworking
      ELSEIF
      UE mobility state is HIGH and cell parameter
UeMobilityHigh3gppWlanInterworking is set to Not Allowed, block
3GPP-WLAN interworking
      ELSE
      proceed with 3GPP-WLAN interworking according to standards
      ENDIF
```

In alternative embodiments, however, it is possible that the condition for interworking with a WLAN network and its associated mobility characteristics of the wireless terminal is based on velocity of the wireless terminal. In this embodiment the parameter indicative of mobility characteristics of the wireless terminal associated with the received condition is velocity above which interworking with a WLAN network is not allowed. The velocity of the wireless terminal is determined using triangulation, GPS or similar technology (e.g. GLONASS).

In further embodiment of the method, if interworking is not allowed, the wireless terminal disables 212 scanning frequencies allocated to WLAN networks (e.g. 2.4 GHz and 5 GHz for WiFi networks). Disabling of the operation of scanning has the advantage of further reduction of battery consumption. If interworking is not allowed the wireless terminal will not connect to a WLAN network even if it is in a range of this WLAN network. If the searching for available WLANs is disabled resources are freed and less energy is consumed. In yet another embodiment the whole WLAN transceiver is switched off, 216, if the interworking is not allowed.

Disabling scanning and switching off the WLAN transceiver is beneficial when the wireless terminal moves too fast and is not allowed to connect to a WLAN network. This, however is only an optional feature because if the terminal is on a moving train then the mobility characteristics of the wireless terminal determined by 3GPP cell reselections or by ground speed would result in mobility characteristics Medium or High. However, it would be safe to interwork with the WLAN cell on this train. In the scenario with the wireless terminal on board of a train if the wireless terminal knows that the WLAN access point is on-board, and in effect stationary with reference to the wireless terminal, then the wireless terminal can override the 3GPP-WLAN interworking parameters received in the system information. This requires additional information identifying said access point as a moving one which the wireless terminal receives from the train's WLAN access point. In this way the wireless terminal knows it connects a network on the train.

On the other hand if the wireless terminal has High or Medium mobility because it is in a car on a motorway, and for simplicity it is assumed that there is no WLAN access point in this car, then it is safe to at least switch off scanning of WLAN frequencies or even turn off the WLAN transceiver as discussed earlier.

Preferably, the switching off the WLAN transceiver is conditional. The WLAN transceiver of the wireless terminal is turned off if, 214, the wireless terminal is not connected to any WLAN network.

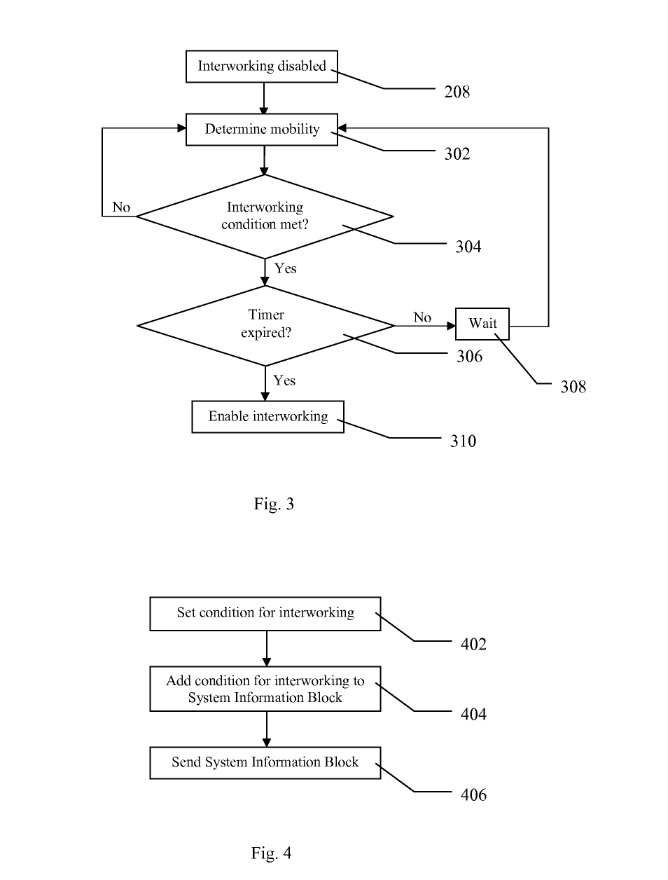

As explained earlier, depending on current mobility characteristics of the wireless terminal interworking may be allowed or not allowed and the wireless terminal may transition between these states in response to its changing mobility characteristics. As illustrated in FIG. 3, preferably, transition from a state in which interworking is not allowed to a state in which interworking is allowed is permitted if, 306, the determined mobility characteristics, 302, suitable for interworking with a WLAN network is met, 304 and maintained for a period of time 306, 308 equal to or longer than a defined threshold. Again, this embodiment is applicable to the train scenario. Assuming that the wireless terminal is not connected to an on-board WLAN access point its mobility is Medium or High and interworking is not allowed. If the train stops at a station the mobility characteristics drops to Normal, but only for a very short period of time. If there is a WLAN access point at the station the current mobility characteristics would allow for interworking. However, the stop will be too short and soon after the train departs it will be necessary to switch back to the 3GPP network. If there is a timer set and after expiry of the timer the mobility still qualifies for interworking then it should be allowed. The timer defines a threshold which, if exceeded, means that the drop in mobility characteristics is long enough to allow for interworking. The timer creates hysteresis that keeps the wireless terminal is status “interworking not allowed” longer that it is needed in order to filter out short and accidental drops in mobility characteristics. In real life when the wireless terminal travels in a car or on a there will be a number of short stops caused by traffic lights, train stations, etc. With large number of WLAN access points this would result in larger number of interworking attempts when the vehicle carrying the wireless terminal stops at traffic lights or a station in a range of WLAN AP.

Preferably the condition for interworking with a WLAN network associated with mobility characteristics of the wireless terminal is set individually for each cell. This means that in each cell the wireless terminal receives System Information Block with a parameter defining a condition for interworking with WLAN networks. However, if a new condition for interworking with a WLAN network is not received after the wireless terminal roams to a new cell the wireless terminal maintains the condition for interworking with a WLAN network received in a previous cell. The most likely scenario in which the wireless terminal fails to receive a new condition for interworking is when the wireless terminal roams into a legacy cell that does not support a solution in accordance with embodiments of the present invention.

With reference to FIG. 4 an embodiment of a method for controlling interworking of a wireless terminal between the 3GPP wireless communications network and a Wireless Local Area Network is presented. The method is implemented in a node of a 3GPP wireless communications network and the method comprises setting 402 a condition for interworking with a WLAN network. The condition is associated with mobility characteristics of a wireless terminal. In a following step the method comprises adding 404 said condition associated with said mobility characteristics to a system information block. The node then sends 406 said system information block to a wireless terminal. Said condition associated with said mobility characteristics causes disabling interworking with the WLAN network if a parameter indicative of mobility characteristics of the terminal does not meet the condition.

System Information (SI) and its content is network controlled and it is the provisioning of these parameters defining conditions for interworking in SI which effectively controls this feature.

As discussed earlier, preferably transition from a state in which interworking is not allowed to a state in which interworking is allowed is permitted if mobility characteristics of the wireless terminal suitable for interworking with a WLAN network is maintained for a period of time equal to or longer than a defined threshold. In a preferred embodiment crossing the threshold is controlled by a timer.

With reference to FIG. 5 an embodiment of a wireless terminal, 500, in accordance with the present invention is presented. The wireless terminal, 500, is configured for operation in a 3GPP wireless communications network. The wireless terminal, 500, comprises a processor, 502, and a memory, 504, wherein said memory contains instructions executable by said processor. The wireless terminal, 500, also comprises a 3GPP transceiver, 506, and a WLAN transceiver 508. By executing the instructions stored in the memory 504 the wireless terminal, 500, is configured to receive system information comprising a condition for interworking with a WLAN network, wherein the condition is associated with mobility characteristics of the wireless terminal. In a preferred embodiment the wireless terminal determines a parameter indicative of its mobility characteristics based on 3GPP Technical Specification 36.304 V11.5.0. In this embodiment mobility characteristics of the wireless terminal can have one of three values, Normal, Medium or High, and it is determine based on number of cell reselection is a defined period of time. In alternative embodiments mobility characteristics may be determined by measurements or estimations of velocity of the wireless terminal using triangulation or satellite based techniques (e.g. GPS or GLONASS). Once the parameter indicative of mobility characteristics is known the wireless terminal is configured to disable interworking with a WLAN network if said parameter indicative of mobility characteristics does not meet the condition.

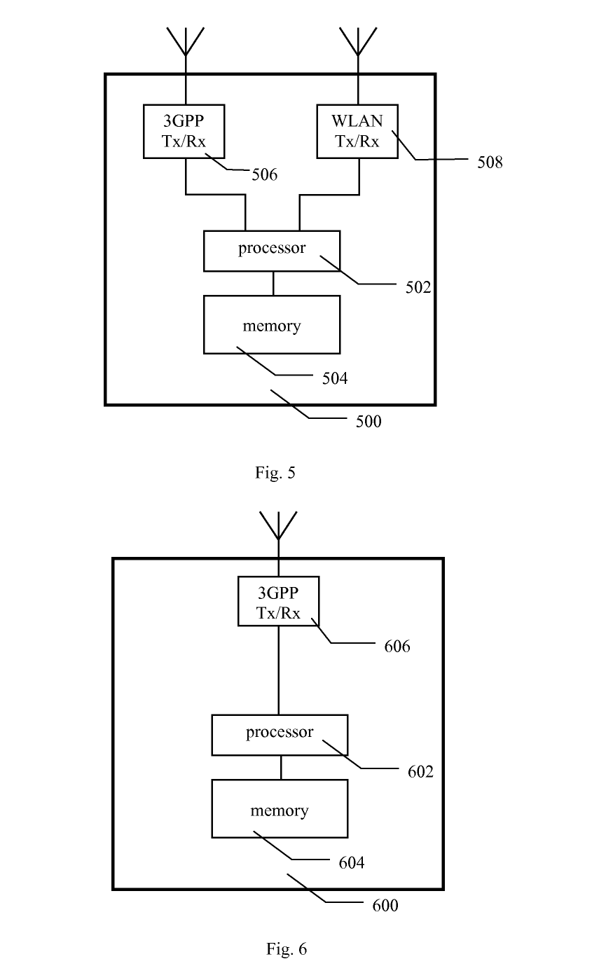

A node, 600, for a 3GPP wireless communications network in accordance with an embodiment of the present invention is presented in FIG. 6. The node, 600, is configured for controlling interworking of a wireless terminal between the 3GPP wireless communications network and a Wireless Local Area Network, WLAN. In real life the node controls interworking of a plurality of wireless terminals, but for the sake of simplicity the description is based on an example of just one wireless terminal. The node comprises a transceiver, 606, a processor, 602, and a memory, 604. Said memory stores instructions executable by said processor. The node 600 is configured to set a condition for the wireless terminal interworking with a WLAN network wherein the condition is associated with mobility characteristics of said wireless terminal. The node 600 is further configured to add the condition associated with said mobility characteristics to system information and send the system information to a wireless terminal. When received by the wireless terminal the condition associated with said mobility characteristics causes disabling the wireless terminal interworking with the WLAN network if the parameter indicative of mobility characteristics of the terminal does not meet the condition. If the parameter indicative of mobility characteristics of a wireless terminal meets the condition then 3GPP/WLAN interworking is allowed for the wireless terminal.

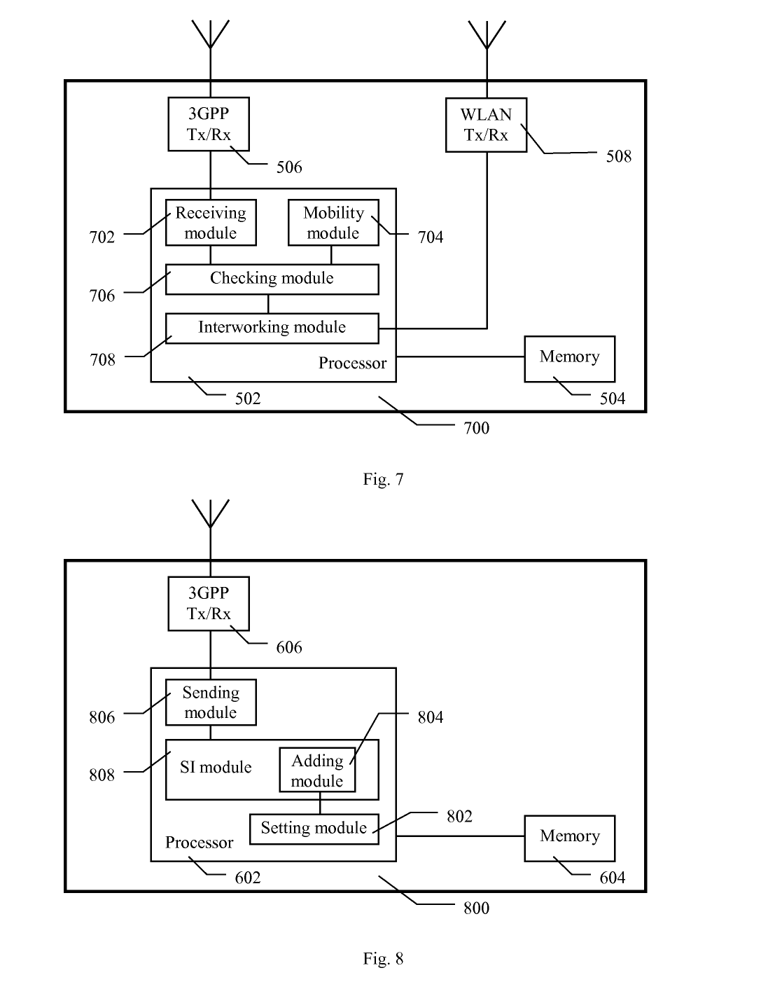

Yet another embodiment of a wireless terminal 700 for a 3GPP wireless communications network, in accordance with the present invention, is presented in FIG. 7. The wireless terminal comprises a receiving module 702 configured for receiving system information. The system information comprises a parameter defining a condition for interworking with a WLAN network. The parameter is associated with mobility characteristics of the wireless terminal 700. The wireless terminal further comprises a determining module 704 for determining a parameter indicative of mobility characteristics of the wireless terminal 700 and a checking module 706 for checking if the determined parameter indicative of mobility characteristics of the wireless terminal meet the condition for interworking with a WLAN network. The wireless terminal also comprises an interworking module 708 configured for disabling interworking with a WLAN network if the parameter indicative of mobility characteristics does not meet the condition.

In a preferred embodiment the receiving module 702, determining module 704, checking module 706 and interworking module 708 are implemented as software modules operating in a processor 502. In alternative embodiments the modules 702-708 may be implemented as hardware modules.

Preferably the interworking module 708 is configured to disable scanning frequencies allocated to WLAN networks and in another embodiment said interworking module is configured to turn off a WLAN transceiver 508 of the wireless terminal 700. However, in order to avoid tearing off existing connections to WLAN networks that may operate well in a preferred embodiment the interworking module 708 is configured to turn off the WLAN transceiver 508 if the wireless terminal 700 is not connected to any WLAN network. This situation may take place when the wireless terminal is on board of a moving train and is connected to an on-board WiFi AP.

Preferably the interworking module 708 permits transition from a state in which interworking is not allowed to a state in which interworking is allowed if the mobility characteristics suitable for interworking with a WLAN network is maintained for a period of time equal or longer than a defined threshold. This embodiment allows for creating a hysteresis that keeps the wireless terminal is status “interworking not allowed” longer that it is needed in order to filter out short and accidental drops in mobility characteristics as discussed earlier.

In yet another embodiment the interworking module 708 maintains the condition for interworking with a WLAN network received in a previous cell if a new condition for interworking with a WLAN network is not received after the wireless terminal roamed to a new cell. As discussed earlier, this may happen when the wireless terminal roams into a legacy cell that does not support a solution in accordance with embodiments of the present invention.

Another embodiment of a node 800 for a 3GPP wireless communications network is illustrated in FIG. 8. The node is configured for controlling a wireless terminal interworking between the 3GPP wireless communications network and a Wireless Local Area Network, WLAN. The node comprises a setting module 802 configured for setting a parameter defining a condition for interworking with a WLAN network. The parameter is associated with mobility characteristics of a wireless terminal and an adding module 804 for adding parameter defining a condition for interworking to system information. The node also comprises a sending module 806 for sending said system information to a transceiver 606 of the node 800 for a wireless transmission to a wireless terminal. Said condition associated with said mobility characteristics causes disabling 3GPP-WLAN interworking if the parameter indicative of mobility characteristics of the terminal does not meet the condition. In a preferred embodiment the adding module is part of a module producing System Information (SI module), 808.

While the primary objective of the various embodiments of the present invention is to protect the user experience in 3GPP-WLAN interworking deployments the following advantages also apply:
Reduced network signalling as the ping pong effect of moving between 3GPP and WLAN and also within WLAN (AP-AP) will be avoided.
Battery life in UE will be increased.
Existing users experience on WLAN will be protected.
Additional low mobility users trying to access WLAN will not be blocked.
Data throughput on WLAN will be increased.
In the prior art solutions, depending on associated service set identifier (SSID), wireless terminals with mobility above NORMAL and a high SSID priority may be forcing existing WLAN connected users with lower SSID priority off the WLAN if the WLAN access point AP is under load already. This situation will be avoided if 3GPP-WLAN interworking is controlled in accordance with embodiments of the present invention.

1-25. (canceled)

26. A method in a wireless terminal operating in a 3GPP wireless communications network for controlling interworking with a Wireless Local Area Network, WLAN, comprising:
receiving system information comprising a parameter defining a condition for interworking with a WLAN network associated with mobility characteristics of the wireless terminal;
determining a parameter indicative of mobility characteristics of the wireless terminal;
disabling interworking with a WLAN network if the parameter indicative of mobility characteristics does not meet the condition.

27. The method according to claim 26 further comprising disabling scanning frequencies allocated to WLAN networks.

28. The method according to claim 26 further comprising turning off a WLAN transceiver of the wireless terminal.

29. The method according to claim 28, wherein the WLAN transceiver of the wireless terminal is turned off if the wireless terminal is not connected to any WLAN network.

30. The method according to claim 26, wherein the parameter defining a condition for interworking defines velocity above which interworking with a WLAN network is not allowed.

31. The method according to claim 26, wherein transition from a state in which interworking is not allowed to a state in which interworking is allowed is permitted if the mobility characteristics suitable for interworking with a WLAN network is maintained for a period of time equal to or longer than a defined threshold.

32. The method according to claim 26, wherein the condition for interworking with a WLAN network associated with mobility characteristics of the wireless terminal is set individually for each cell.

33. The method according to claim 26, wherein the wireless terminal maintains the condition for interworking with a WLAN network received in a previous cell if a new condition for interworking with a WLAN network is not received after the wireless terminal roamed to a new cell.

34. A wireless terminal for a 3GPP wireless communications network, the wireless terminal comprising a processor and a memory, said memory containing instructions executable by said processor whereby said wireless terminal is configured to:
receive system information comprising a parameter defining a condition for interworking with a WLAN network associated with mobility characteristics of the wireless terminal;
determine a parameter indicative of mobility characteristics of the wireless terminal;
disable interworking with a WLAN network if the parameter indicative of mobility characteristics does not meet the condition.

35. The wireless terminal according to claim 34, further configured to disable scanning frequencies allocated to WLAN networks.

36. The wireless terminal according to claim 34, further configured to turn off a WLAN transceiver of the wireless terminal.

37. The wireless terminal according to claim 36, wherein the wireless terminal is configured to turn off the WLAN transceiver if the wireless terminal is not connected to any WLAN network.

38. The wireless terminal according to claim 34 further configured to permit transition from a state in which interworking is not allowed to a state in which interworking is allowed if the mobility characteristics suitable for interworking with a WLAN network is maintained for a period of time equal or longer than a defined threshold.

39. The wireless terminal according to claim 34, wherein the wireless terminal is configured to maintain the condition for interworking with a WLAN network received in a previous cell if a new condition for interworking with a WLAN network is not received after the wireless terminal roamed to a new cell.

40. A node for a 3GPP wireless communications network the node being configured for controlling interworking of a wireless terminal between the 3GPP wireless communications network and a Wireless Local Area Network, WLAN, the node comprising a processor and a memory, said memory containing instructions executable by said processor whereby said node is configured to:
set a parameter defining a condition for interworking with a WLAN network associated with mobility characteristics of a wireless terminal;
add said parameter defining a condition for interworking to system information;
send said system information to a wireless terminal, wherein said condition associated with said mobility characteristics causes disabling interworking with the WLAN network if the parameter indicative of mobility characteristics of the terminal does not meet the condition.
